(19) United States
(12) Patent Application Publication
(10) Pub. No.: US 2026/0089251 A1
(43) Pub. Date: Mar. 26, 2026

(54) RECEIVING AND PRESENTING NOTIFICATIONS BASED ON ENVIRONMENTAL CONTEXT

(71) Applicant: Apple Inc., Cupertino, CA (US)

(72) Inventors: Jessica TRINH, Oakland, CA (US); Benjamin S. PHIPPS, San Francisco, CA (US); Alexandria G. HESTON, San Francisco, CA (US); Sanjana WADHWA, San Francisco, CA (US); Harry J. SADDLER, Berkeley, CA (US)

(21) Appl. No.: 19/301,512

(22) Filed: Aug. 15, 2025

Related U.S. Application Data
(60) Provisional application No. 63/697,105, filed on Sep. 20, 2024.

(51) Int. Cl. H04M 1/72454; G06F 3/01; H04M 1/72409; H04M 1/72436; H04M 1/72457

(52) U.S. Cl. CPC H04M 1/72454; G06F 3/011; H04M 1/72409; H04M 1/72436; H04M 1/72457

(57) ABSTRACT

Some examples of the disclosure are directed to systems and methods for receiving and presenting notifications based on environmental context, and more particularly to receiving and presenting notifications while in different levels of busyness on an extended reality device. In some examples, the electronic device receives a notification while at a first level of busyness. In some examples, the electronic device determines the importance of the notification based on previous user interactions with the notification's sender and/or based on the contents of the notification. In some examples, the electronic device presents an indication of the notification when the importance of the notification is greater than the importance threshold at the first level of busyness.

### CROSS REFERENCE TO RELATED APPLICATIONS

This application claims the benefit of U.S. Provisional Application No. 63/697,105, filed Sep. 20, 2024, the content of which is herein incorporated by reference in its entirety for all purposes.

### FIELD OF THE DISCLOSURE

This relates generally to systems and methods for receiving and presenting notifications based on environmental context, and more particularly to receiving and presenting notifications while in different levels of busyness on an extended reality device.

### BACKGROUND OF THE DISCLOSURE

Some computer graphical environments provide two-dimensional and/or three-dimensional environments where at least some objects displayed for a user's viewing are virtual and generated by a computer. In some examples, the objects include notifications presented on the electronic device.

### SUMMARY OF THE DISCLOSURE

Some examples of the disclosure are directed to systems and methods for receiving and presenting notifications based on environmental context, and more particularly to receiving and presenting notifications while in different levels of busyness on an extended reality device. In some examples, the electronic device receives a notification while at a first level of busyness. In some examples, the electronic device determines the importance of the notification based on previous user interactions with the notification's sender and/or based on the contents of the notification. In some examples, the electronic device presents an indication of the notification when the importance of the notification is greater than the importance threshold at the first level of busyness.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIG. 3A-3E illustrate different scenarios for presentation of an indication of a notification on the electronic device according to some examples of the disclosure.

FIG. 4 is a block diagram that illustrates the determination process of whether an electronic device presents an indication of a notification according to some examples of the disclosure.

FIG. 5A-5C illustrate examples of the electronic device 101 receiving and presenting notifications associated with respective locations according to some examples of the disclosure.

FIG. 6 illustrates a flow diagram illustrating an example process for presenting an indication of a notification according to some examples of the disclosure.

### DETAILED DESCRIPTION

Some examples of the disclosure are directed to systems and methods for receiving and presenting notifications based on environmental context, and more particularly to receiving and presenting notifications while in different levels of busyness on an extended reality device. In some examples, the electronic device receives a notification while at a first level of busyness. In some examples, the electronic device determines the importance of the notification based on previous user interactions with the notification's sender and/or based on the contents of the notification. In some examples, the electronic device presents an indication of the notification when the importance of the notification is greater than the importance threshold at the first level of busyness.

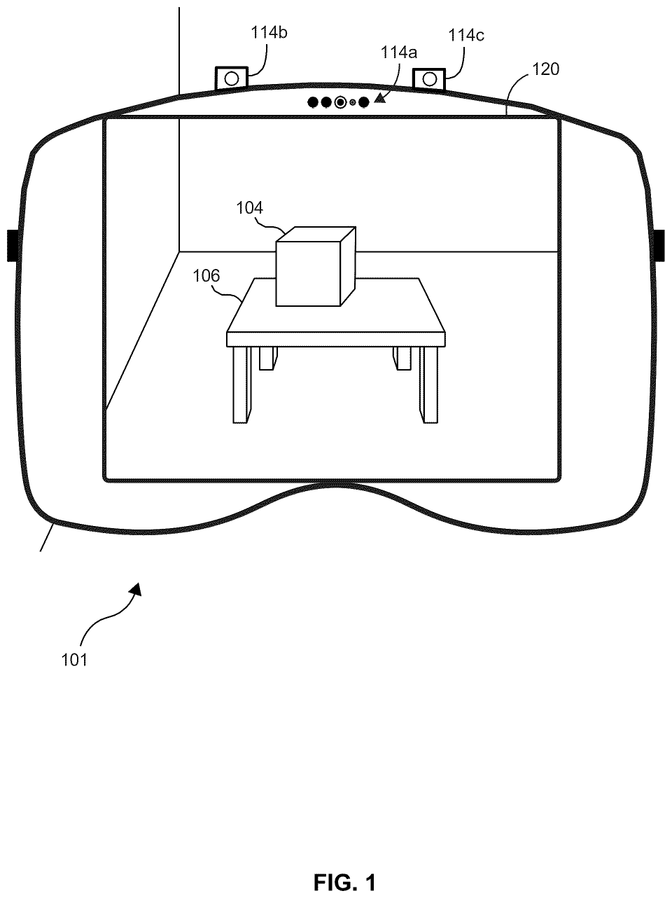

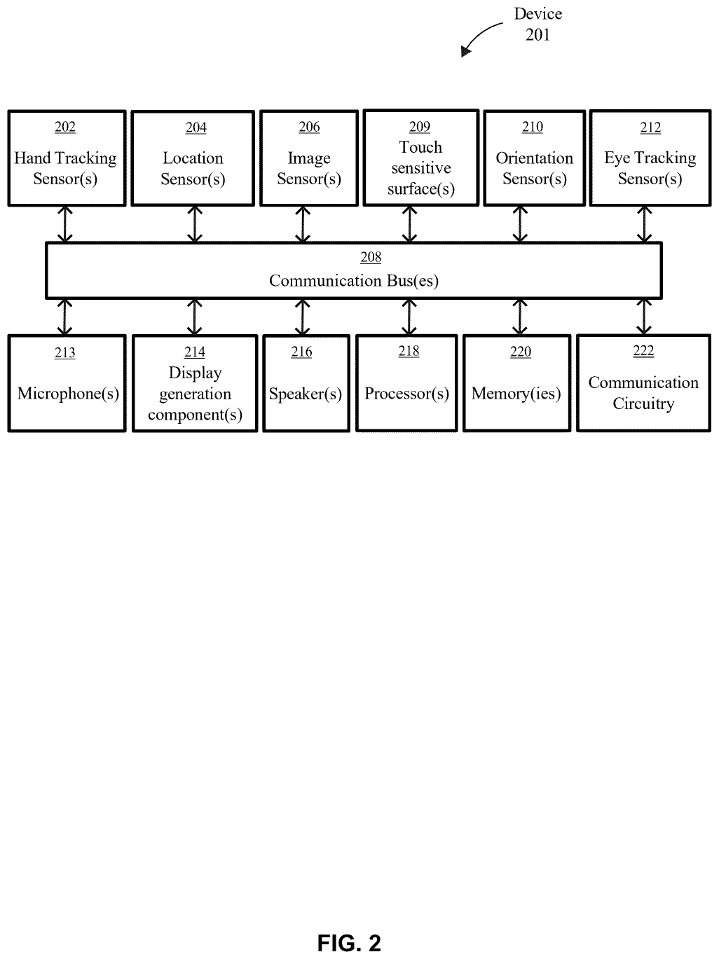

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specfies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIG. 2, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment.

For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not).

Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for an electronic device 201 according to some examples of the disclosure. In some examples, electronic device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

Processor(s) 218 include one or more general processors, one or more graphics processors, and/or one or more digital signal processors. In some examples, one or more processor(s) 218 include one or more microprocessors, one or more central processing units, one or more application-specific integrated circuits, one or more field-programmable gate arrays, one or more programmable logic devices, or a combination of such devices. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, the electronic device does not include one or more display generation component(s) 214. For example, instead of the one or more display generation component(s) 214, some electronic devices include transparent or translucent lenses or other surfaces that are not configured to display or present virtual content. However, it should be understood that, in such instances, the electronic device 201 is optionally equipped with one or more of the other components illustrated in FIG. 2 and described herein, such as the one or more hand tracking sensors 202, one or more eye tracking sensors 212, sensor(s) 206, and/or the one or more motion and/or orientations sensors 210. Alternatively, in some examples, the one or more display generation component(s) 214 are provided separately from the electronic device 201. For example, the one or more display generation component(s) 214 are in communication with the electronic device 201, but are not integrated with the electronic device 201 (e.g., within a housing of the electronic device 201). In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensor(s) 206 are included in an electronic device different from the electronic devices 201. For example, the sensor(s) 206 are in communication with the electronic device 201 but are not integrated with the electronic device 201 (e.g., within a housing of the electronic device 201). Particularly, in some examples, the one or more cameras of the one or more image sensor(s) 206 are integrated with and/or coupled to one or more separate devices from the electronic devices 201 (e.g., but are in communication with the electronic devices 201), such as one or more input and/or output devices (e.g., one or more speakers and/or one or more microphones, such as earphones or headphones) that include the one or more image sensor(s) 206. In some examples, electronic device 201 corresponds to a head-worn speaker (e.g., headphones or earbuds). In such instances, the electronic device 201 is equipped with a subset of the other components illustrated in FIG. 2 and described herein. In some such examples, the electronic device 201 is equipped with one or more image sensor(s) 206, the one or more motion and/or orientations sensors 210, and/or speakers 216.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker. In some examples, electronic device 201 alternatively does not include the one or more hand tracking sensors 202 and/or the one or more eye tracking sensors 212. In some such examples, the one or more display generation components 214 may be utilized by the electronic device 260 to provide a three-dimensional environment and the electronic device 260 may utilize input and other data gathered via the other one or more sensors (e.g., the one or more location sensors 204, the one or more image sensors 206, the one or more touch-sensitive surfaces 209, the one or more motion and/or orientation sensors 210, and/or the one or more microphones 213 or other audio sensors) of the electronic device 201 as input and data that is processed by the one or more processors of a second electronic device in communication with electronic device 201.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards presentation of notifications in accordance with busyness of a user of the electronic device. The notifications are optionally presented as one or more virtual objects in a three-dimensional environment presented at an electronic device (e.g., corresponding to electronic device 201). In some examples, an electronic device presents indications of notifications from different applications differently based on a busyness level of the electronic device (and of the user) and based on previous interactions with respective types of notifications. In some examples, the electronic device uses one or more input devices (e.g., image sensor(s) 206, orientation sensor(s) 210, audio sensors, and other sensors) to determine a busyness level of the user, which optionally dictates an importance threshold of the electronic device. In some examples, the electronic device determines an importance of a notification (e.g., based on at least the contents of the notification). In some examples, when the importance of the notification exceeds the importance threshold, the electronic device presents an indication of the notification on the electronic device. In some examples, when the importance of the notification does not exceed the importance threshold, the electronic device does not present the indication of the notification on the electronic device. In some examples, presenting notifications at an opportune time allows the user to efficiently view notifications without distractions.

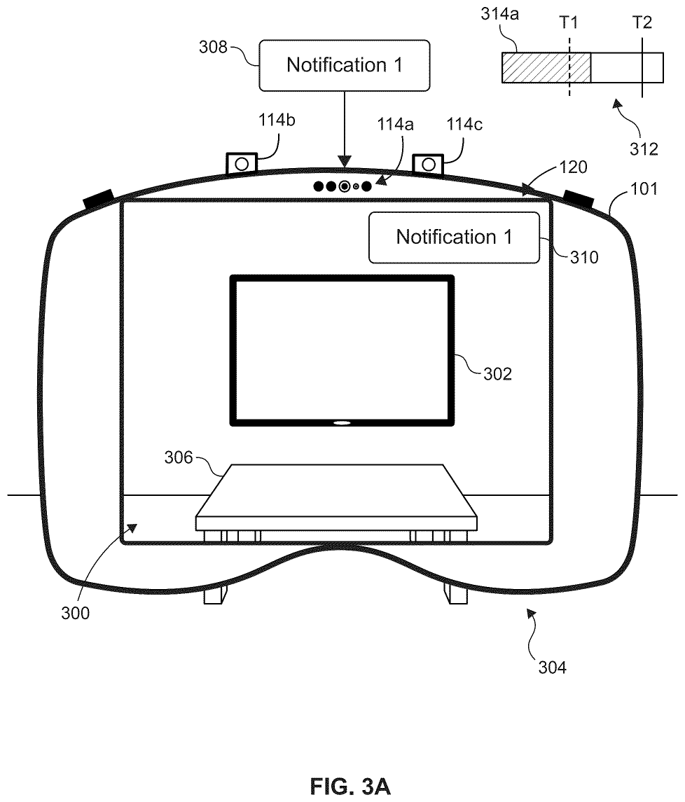

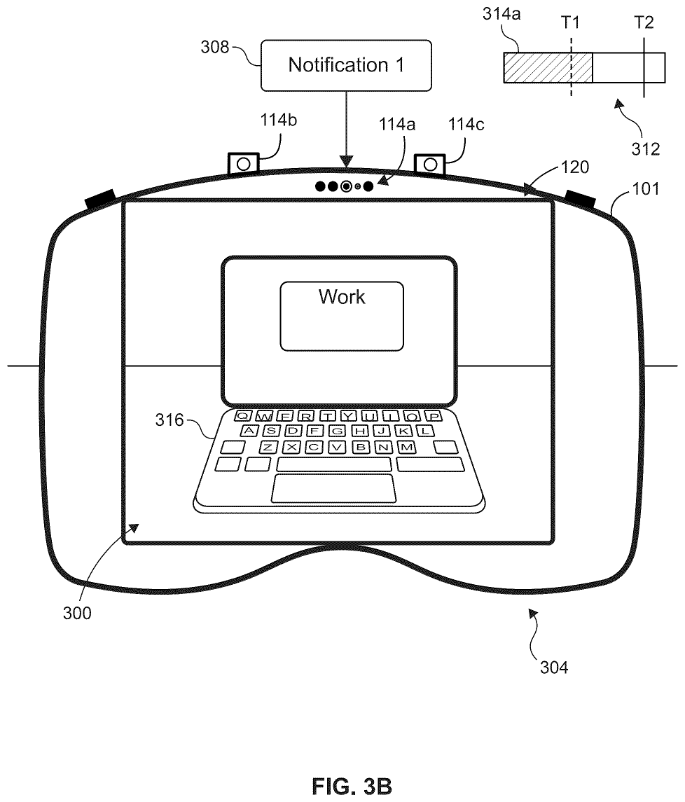

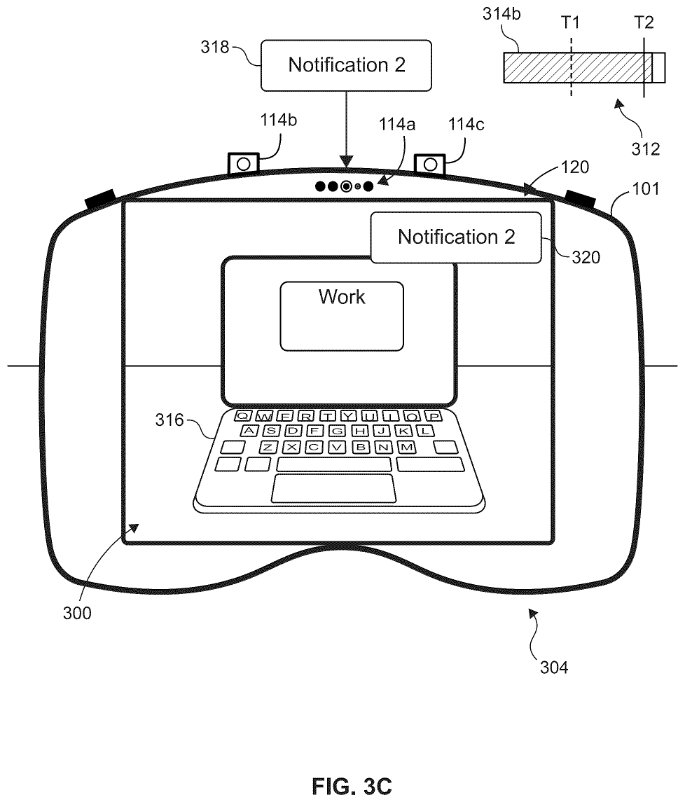

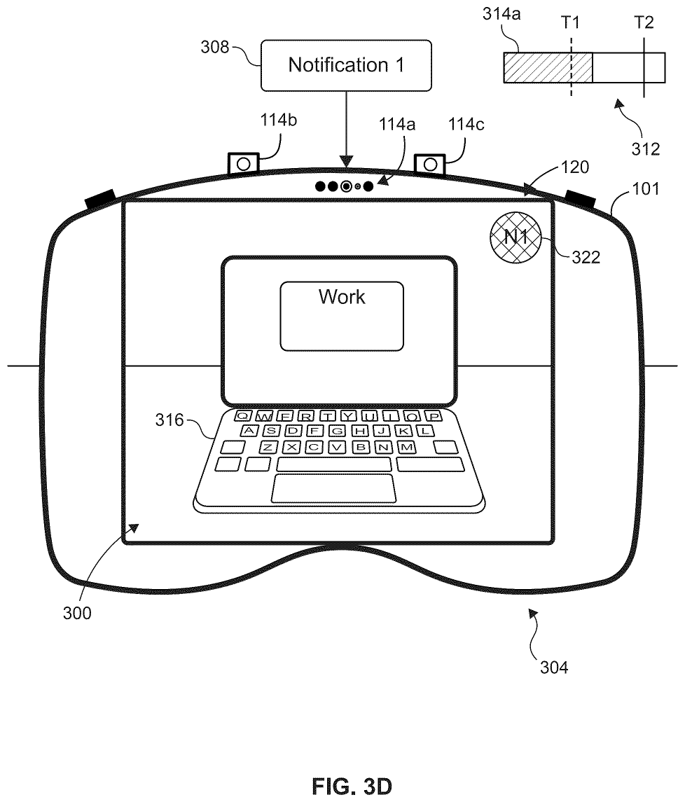

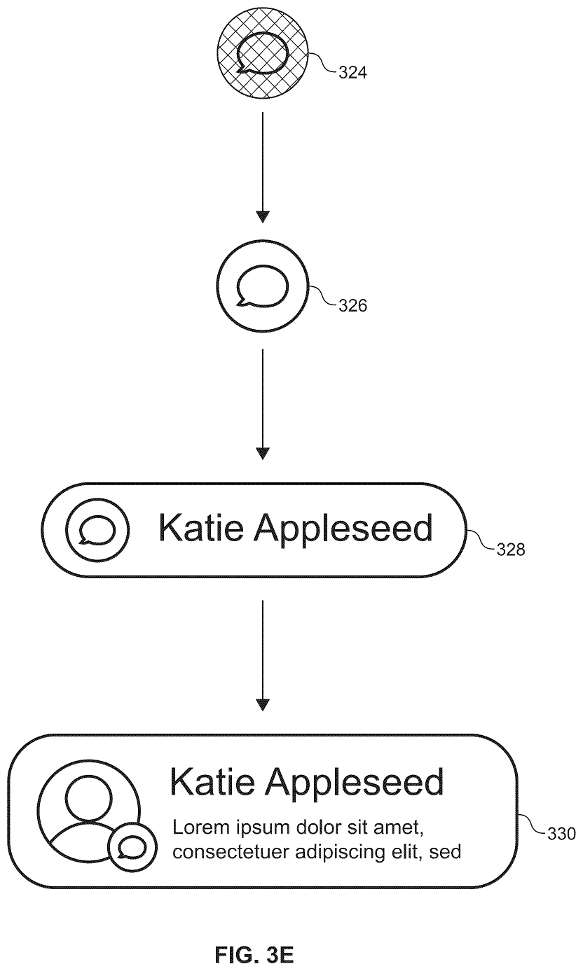

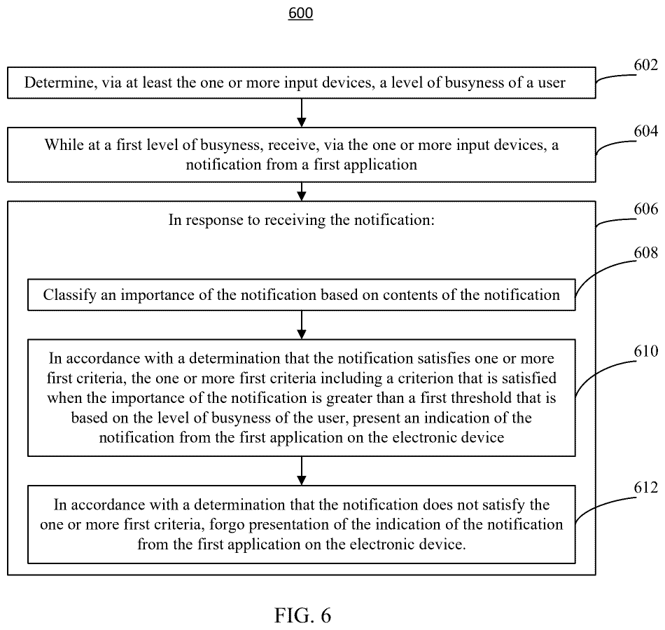

FIG. 3A-3E illustrate different scenarios for presentation of an indication of a notification on the electronic device. FIGS. 3A-3E are used to illustrate the processes described below, including process 600, shown in FIG. 6.

FIG. 3A illustrates an electronic device 101 presenting, via the display 120, a three-dimensional environment 300 from a point of view of the user of the electronic device 101. For example, the three-dimensional environment includes a room with a television 302 and a coffee table 306. FIG. 3A shows the user of the electronic device 101 is facing the television 302 and coffee table 306 in a room in which electronic device 101 is located. In some examples, a viewpoint of a user determines what content (e.g., physical and/or virtual objects) is visible in a viewport (e.g., a view of the three-dimensional environment 300 visible to the user via one or more displays 120, a display, or a pair of display modules that provide stereoscopic content to different eyes of the same user). In some examples, the (virtual) viewport has a viewport boundary that defines an extent of the three-dimensional environment 300 that is visible to the user via the display 120 in FIGS. 3A-3E. In some examples, the region defined by the viewport boundary is smaller than a range of vision of the user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the user in one or more dimensions (e.g., based on the range of vision of the user, size, optical properties or other physical characteristics of the one or more displays, and/or the location and/or orientation of the one or more displays relative to the eyes of the user). The viewport and viewport boundary typically move as the one or more displays move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and a direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include displays with video passthrough, portions of the physical environment that are visible (e.g., displayed, and/or projected) via the one or more displays are based on a field of view of one or more cameras in communication with the displays which typically move with the displays (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more displays is updated based on the viewpoint of the user (e.g., displayed positions and poses of the virtual objects are updated based on the movement of the viewpoint of the user)). For displays with optical see-through, portions of the physical environment that are visible (e.g., optically visible through one or more partially or fully transparent portions of the display generation component) via the one or more displays are based on a field of view of a user through the partially or fully transparent portions of the display generation component (e.g., moving with a head of the user for a head mounted device or moving with a hand of a user for a handheld device such as a tablet or smartphone) because the viewpoint of the user moves as the field of view of the user through the partially or fully transparent portions of the displays moves (and the appearance of one or more virtual objects is updated based on the viewpoint of the user).

In FIG. 3A, the electronic device 101 includes a display 120 and a plurality of sensors as described above and controlled by the electronic device 101 to capture one or more images of a user or part of a user (e.g., one or more hands of the user) while the user interacts with the electronic device 101. In some examples, virtual objects, virtual content, and/or user interfaces illustrated and described below could also be implemented on a head-mounted display that includes a display or display generation component that displays the virtual objects, virtual content, user interfaces or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user). The figures herein illustrate a three-dimensional environment that is presented to the user by electronic device 101 (e.g., and displayed by the display 120 of electronic device 101). In some examples, electronic device 101 may be similar to electronic device 101 in FIG. 1, or electronic device 201 in FIG. 2, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively.

As shown in FIG. 3A, the electronic device 101 captures (e.g., using external image sensors 114b and 114c) one or more images of a physical environment 304 around electronic device 101, including one or more objects (e.g., television 302 and coffee table 306) in the physical environment 304 surrounding the electronic device 101. In some examples, the electronic device 101 displays representations of the physical environment 304 in the three-dimensional environment or portions of the physical environment 304 are visible via the display 120 of electronic device 101. For example, the three-dimensional environment 300 includes television 302 and coffee table 306 in the physical environment 304.

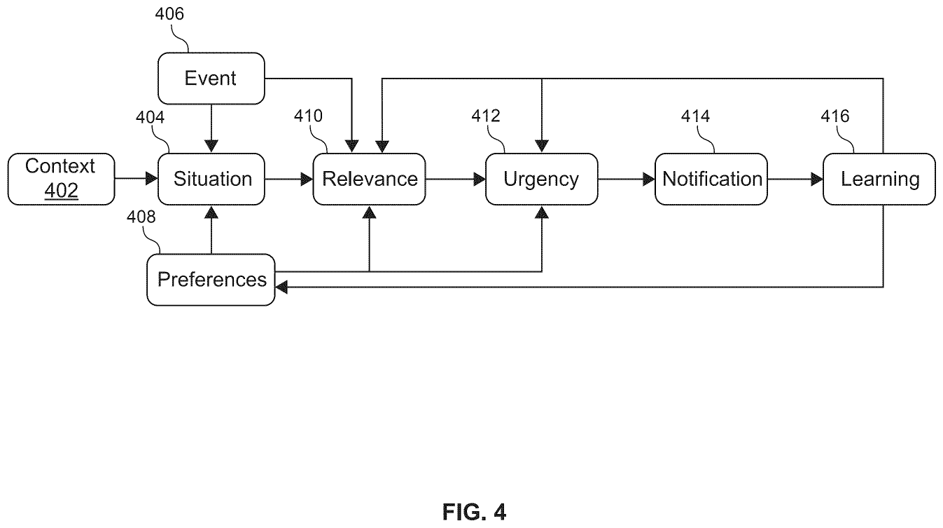

In FIG. 3A, the electronic device 101 is in a first busyness level. The electronic device 101 uses environmental context to determine the busyness level. For example, in FIG. 3A, the electronic device 101 detects, using the one or more input devices such as the image sensors, microphones, position sensors, orientation sensors, and/or location sensors as described in FIG. 2, that the user is passively viewing the television 302 in the three-dimensional environment 300 and assigns a first busyness level. Specifically, the user may not be fully focused on the television (e.g., the lights are on, the user is conversing with a second person, the user is using multiple devices while watching television, or other actions indicating that the user is passively participating in the activity of watching television). In some examples, the environmental context includes fixation of gaze (e.g., low fixation of gaze corresponds to a low busyness level and vice versa), interactions with one or more people in the physical environment, whether the user is talking, driving, exercising, or the like. The determination of the busyness level is described in greater detail in FIG. 4. In some examples, the electronic device 101 assigns a busyness level based on how much a user is participating and/or interacting with the physical environment or an activity in the physical environment or based on a current activity in the physical environment.

In some examples, the electronic device 101 includes an importance threshold. In some examples, notifications received by the electronic device 101 are assigned an importance level and the electronic device 101 displays indications of respective notifications that have a respective importance level greater than the threshold importance level. In some examples, the electronic device 101 sets the threshold at or above which the electronic device 101 presents a notification based on the busyness level of the electronic device 101 and/or changes the threshold based on changes in the busyness level. For example, in FIG. 3A, multiple thresholds are illustrated using a bar 312 representing importance of a notification and multiple importance thresholds. For example, the thresholds include a first importance threshold T1 corresponding to a first busyness level and a second importance threshold T2 corresponding to a second busyness level. While in the first busyness level, the threshold importance to present a notification is lower (e.g., first importance threshold T1) than while in a second busyness level that is busier than the first busyness level (e.g., second importance threshold T2).

In FIG. 3A, the electronic device 101 receives, via the one or more input devices, a notification 308 from a first application. For example, the notification 308 is a message from a messaging application, a notification from a social media application, a notification from a gaming application, or notifications from other applications. The notification 308 is optionally received from another electronic device in communication with electronic device 101 and/or from an application operating on the electronic device 101. The notification 308 has an importance level, represented as importance level 314a in bar 312 in FIG. 3A. In the first level of busyness in FIG. 3A, the importance threshold T1, shown in bar 312, is used to determine whether to present the notification. Because the importance level 314a is greater than the importance threshold T1, the electronic device 101 presents an indication 310 of the notification in the three-dimensional environment 300.

In some examples, the importance level of the notification is based on the content of the notification. For example, determining the importance level of the notification based on the content of the notification is performed using artificial intelligence and/or machine learning model such as a large language model. The text or images in the notification can be input into an artificial intelligence and/or machine learning model trained to output an importance of the message. For example, when the contents of the notification are relatively low importance (e.g., the contents do not indicate a time-sensitivity or other indications of importance), as determined by artificial intelligence and/or machine learning such as a large language model, the notification can be assigned a relatively low level of importance, whereas when the contents of the notification are relatively high importance (e.g., the contents indicate a time-sensitivity or other indications of importance), the notification can be assigned a relatively high level of importance. In some examples, the electronic device uses one or more classifiers to classify an importance of a notification.

In some examples, the electronic device does not use artificial intelligent and/or machine learning to determine importance based on the contents of the notification. In some examples, the electronic device identifies keywords to determine importance. For example, keyworks such as critical, important, urgent, attention may cause the electronic device to assign a high level of importance to the respective notification. In some examples, keywords corresponding to ads such as sale, buy, or shopping may cause the electronic device to assign a lower level of importance to the respective notification. In some examples, a user may preprogram one or more keywords and an importance level associated with the respective keyword. In some examples, the keywords are computer generated.

In some examples, the importance level of the notification is based on the source of the notification. In some examples, some senders or applications can be designated as more important by the user of the electronic device. For example, the user may designate certain contacts as important contacts or applications as important applications, which can cause the importance level of notifications therefrom be relatively increased compared with notifications from contacts or applications without such a designation. In some examples, even without user designations, some contacts or applications can have relatively more importance than others. For example, contacts with whom the user exchanges messages frequently or are included in the user's contact list generally can have relatively more importance than a sender not included in the user's contact lists or with whom the user has not exchanged messages. As another example, a notification from a communication or calendar application can have more importance than a notification from an entertainment application, such as media or gaming applications. In some examples, the sender can include a sender-designated indication of importance. For example, an application or sender may designate an importance level of a notification, such as an indication of high-importance, for some notifications that should be assigned relatively more importance compared with notifications without the designation.

In some examples, prior interactions with notifications from the source of the notification (e.g., the first application or a person sending the message) and/or based on similar notifications influence the importance level of the respective notification. For example, prior interactions (e.g., dismissing the notification, viewing the notification, or acting upon the notification) can be used to indicate the user's view of the importance of such notifications or similar notifications. For example, when a user frequently dismisses notifications sent from a particular sender or application (e.g., without further interaction with the notifications and/or particular application), the system can infer from such prior interactions that the notification is of relatively lesser importance to the user, whereas when the user reads or acts on the notifications, the system can infer from such prior interactions that the notification is of relatively greater importance to the user. Similarly, dismissing, reading, or acting on other types of notifications can provide an indication of importance (e.g., the user dismissed sporting scores that are inferred to be less important, but read news alerts that are inferred to be more important; the user acts on security patches that are inferred to be more important, but delays acting on updating general functionality of applications that is inferred to be less important).

In FIG. 3A, for example, notification 308 is optionally a notification that is not classified as urgent (e.g., relatively low importance). In some examples, even though notification 308 may not be an urgent or a relatively important notification, the importance level 314a of the notification 308 exceeds the relatively lower threshold T1 for the relatively less busy first busyness level.

FIG. 3B illustrates an example where the electronic device 101 is at a second busyness level. The electronic device 101 uses environmental context to determine the busyness level. Additionally, or alternatively, in some examples, the electronic device 101 uses other input devices, such as microphones, position sensors, orientation sensors, and other sensors to determine a busyness level of the electronic device 101. Additionally, or alternatively, in some examples, the electronic device 101 may determine/assign a busyness level based on a focus mode of the electronic device 101, described in greater detail in FIG. 4. Additionally, or alternatively, in some examples, the electronic device 101 uses the one or more applications that are being used (e.g., on the electronic device 101 or on a second electronic device, such as laptop 316 in FIG. 3B), to determine a busyness level. For example, unlike in FIG. 3A, where the electronic device 101 detects passive media consumption and assigns a first busyness level, the electronic device 101 in FIG. 3B detects focused engagement with work and assigns a second busyness level. For example, in FIG. 3B, the electronic device 101 detects laptop 316 in the three-dimensional environment 300. In FIG. 3B, the electronic device 101 detects that the user is working on work on laptop 316. In FIG. 3B, the electronic device 101 detects the environmental context (e.g., the user's gaze is fixated on the laptop 316, a productivity application (e.g., document editing application) is in use on laptop 316, and/or that the user is using one or more input devices of the laptop such as the trackpad and/or keyboard) and causes the electronic device 101 to assign a second level of busyness. As shown in FIG. 3B, the threshold importance to present a notification is higher (e.g., second importance threshold T2) than when the electronic device 101 is at a first busyness level (e.g., first importance threshold T1). In response to receiving notification 308 (e.g., with the same level of importance as notification 308 in FIG. 3A), the electronic device 101 forgoes presenting an indication of the notification on electronic device 101 because the importance level 314a of notification 308 is lower than the second importance threshold T2.

In some examples, the electronic device 101 may suppress presenting the indication of the notification 308 until the electronic device 101 is at a busyness level associated with an importance threshold that is lower than the importance level 314a of notification 308 (e.g., the first busyness level). In some examples, after detecting that the electronic device 101 is at the first busyness level, the electronic device 101 may present the one or more indications of notifications that were suppressed at the second busyness level because the respective importance levels were lower than the second importance threshold (but higher than the first importance threshold). In some examples, the electronic device 101 may present the indication of the notification 308 on a second electronic device when the electronic device 101 is at the second busyness level, as shown in FIG. 3B. For example, the electronic device 101 defers the presentation of notifications that have an importance level lower than the threshold importance level to a second electronic device (e.g., such as a phone, tablet, laptop, and/or watch).

FIG. 3C illustrates an example wherein the electronic device 101 is at a second busyness level and the electronic device 101 presents an indication of a notification. In FIG. 3C, the electronic device 101 receives a notification 318 which has an importance level 314b that is greater than the importance threshold T2. Because of this, the electronic device 101 presents an indication 320 of the notification 318 in the three-dimensional environment 300. In some examples, notification 318 is optionally a notification that is classified as urgent (e.g., the contents of the notification are urgent, as determined by artificial intelligence and/or machine learning such as a large language model as described above), a notification that is from a sender that corresponds to a designated contact (e.g., a frequently contacted contact or a contact that the user of the electronic device 101 assigns as a designated contact), and/or a notification that is frequently viewed by the user based on prior interactions with the notification or similar notifications.

FIGS. 3A-3C primarily focus on a binary of presenting or forgoing presenting the notification based on the level of busyness. In some examples, an appearance of the presentation of a notification may be different depending on the level of importance and/or busyness. FIG. 3D illustrates an example where the electronic device 101 presents an indication of a notification differently based on the importance threshold and the importance level of the notification. FIG. 3D corresponds to a notification with the importance shown in and described with reference to FIGS. 3A-3B, and a level of busyness as shown in and described with reference to FIG. 3B, the details of which are not repeated here for brevity. However, FIG. 3D illustrates an alternative in which a notification is presented, unlike in FIG. 3B, but with an appearance of the notification different than the appearance of the notification presented in FIG. 3A. In FIG. 3D, the electronic device 101 receives a notification 308 from a first application. The notification 308 has an importance level 314a that does not exceed the threshold T2. Rather than forgoing presenting an indication of the notification 308, such as shown in FIG. 3B, the electronic device 101 presents indication 322 corresponding to the notification 308. For example, in FIG. 3A, the indication 310 is displayed with text and images describing the notification because notification 308 has an importance level 314a greater than the threshold importance T1. However, in FIG. 3D, the indication 322 does not include text or graphical representations of the contents of the notification because notification 308 has an importance level 314a lower than the threshold importance T2. In some examples, the appearance of the indication varies based on the importance of the notification and/or the threshold importance level, as shown in FIG. 3E. In FIG. 3D, the electronic device 101 presents indication 322 which is a blurry indication of the notification 308 without text or graphical representations of the contents of the notification because the importance level of the notification 308 does not exceed the required threshold importance level T2. In some examples, if the importance level of notification 308 did exceed the importance level T2, then the electronic device 101 optionally presents the notification 308 with a different visual characteristic, such as indication 326, 328 or 330, shown in FIG. 3E, which include text and/or graphical representations of the contents of the notification. Visual indications 326, 328, and 330 provide progressively (e.g., in list order) more information regarding the respective notification and may be presented with progressively increasing visual prominence. In some examples, if the importance level of the notification is lower than the required threshold level, then the electronic device 101 determines that the notification is not currently important enough to be shown, therefore the electronic device 101 displays visual indication 322, which indicates that the electronic device 101 received a notification without providing additional details (e.g., and therefore providing minimal disruption to the user).

In some examples, in FIG. 3D, the electronic device 101 optionally receives an input directed towards indication 322 (e.g., a direct or indirect input such as a gaze input, an air-selection input such as an air-pinch, a tap input, a click with a mouse or a tap with a stylus, or other inputs). In some examples, the electronic device 101 changes the appearance of the indication 322 in response to receiving the input. FIG. 3E illustrates the flow of the appearances of the indication 322 changing as the electronic device receives the input. For example, as the electronic device 101 receives a gaze input for a first threshold amount of time (e.g., 1 second, 5 seconds, 10 seconds, 30 seconds, or any other desired amount of time) directed towards indication 322, the electronic device 101 updates the appearance of indication 322 in accordance with FIG. 3E. Alternatively or additionally, in some examples, the electronic device 101 updates the appearance of indication 322 in accordance with FIG. 3E after receiving one or more other inputs (e.g., selection inputs) directed towards indication 322.

In some examples, the electronic device 101 ceases presenting indication 322 shown in FIG. 3D after a second threshold amount of time (e.g., 1 second, 5 seconds, 10 seconds, 30 seconds, 1 minute, 5 minutes, or any other desired amount of time) has passed without the electronic device 101 receiving an input directed towards indication 322. For example, while presenting indication 322 in FIG. 3D, the electronic device 101 does not receive a gaze input directed towards indication 322. As a result, the electronic device 101 does not change the appearance of indication 322 and ceases presenting indication 322 after the second threshold amount of time. In some examples, the duration of the second threshold amount of time is based on the importance of the notification. For example, a more important notification has a longer second threshold amount of time than a less important notification so that the electronic device 101 presents the indication of the more important notification for longer before ceasing presenting the indication of the notification.

FIG. 3E illustrates the different appearances of indications of notifications. Indication 324 illustrates an appearance in which the electronic device 101 does not display a textual or graphical representation of the contents of the notification. In some examples, indication 324 indicates that the electronic device 101 received a notification without specifying the contents of the notification, application corresponding to the notification, or the sender of the notification. In some examples, indication 324 includes one or more colors corresponding to the application and/or sender associated with the notification. Indication 326 illustrates an appearance including a graphical representation of the sender and/or application of the notification. The indication 326 optionally also includes one or more colors corresponding to the application and/or sender associated with the notification (e.g., the information from indication 324). Indication 326 includes more information, such as the graphical representation of the sender and/or application of the notification, than indication 324. Indication 328 illustrates an appearance including a graphical and textual representation of the sender and/or application the notification originated from. The indication 328 optionally also includes one or more colors corresponding to the application and/or sender associated with the notification. Indication 328 includes more information, such as the textual description of the sender, than indication 326 and indication 324. Indication 330 illustrates an appearance including a textual representation of a preview of the content of the notification and a graphical and textual representation of the sender and/or application of the notification. The indication 330 optionally also includes one or more colors corresponding to the application and/or sender associated with the notification. Indication 330 includes more information, such as the preview of the contents of the notification, than indication 328, 326, and 324.

In some examples, if the electronic device 101 presents indication 324, 326, or 328 in the three-dimensional environment 300 in response to receiving a notification, the electronic device 101 may update the presentation of the indication in response to receiving an input, such as detecting the attention (e.g., including gaze) of the user directed to the respective indication for the first threshold amount of time. For example, the electronic device 101 presents indication 324; and in response to detecting the attention (e.g., including gaze) of the user directed to the indication 324 for the first threshold amount of time (as described above) or a different threshold amount of time, the electronic device replaces indication 324 with indication 326. In some examples, if the electronic device 101 continues to receive the gaze input directed to indication 326, then the electronic device 101 progresses through the appearances of the indication. For example, in response to continuing to detect the attention (e.g., including gaze) of the user directed to the respective indication of the notification, the electronic device presents indication 326, then indication 328, and then indication 330. In some examples, if the electronic device 101 ceases to receive the gaze input directed to the indication of the notification, then the electronic device 101 stops progressing through the different indications. For example, if the electronic device 101 ceases receiving the gaze input directed to the indication of the notification while presenting indication 328, then the electronic device 101 continues presenting indication 328 for the second threshold of time and then ceases presenting indication 328 after the second threshold of time has passed, as described above.

FIG. 4 is a block diagram that illustrates the determination process of whether an electronic device 101 displays an indication of a notification. In the block diagram, context 402, event 406 and preferences 408 influence a situation 404. The event 406 includes the electronic device 101 receiving (or generating) a notification, such as notification 308 shown in FIG. 3A. The context 402 includes data that is being used to define a situation 404 of the electronic device 101, such as the level of busyness of the electronic device 101 and/or a threshold importance level a notification has to surpass in order to cause the electronic device 101 to present the indication of the notification. In some examples, the context 402 detecting using data from the one or more input devices (e.g., gaze-based data and/or motion data) includes whether the user is interacting with a person (e.g., conversing or other interactions) and/or activities the user is currently performing. In some examples, the context 402 includes a current focus mode of the electronic device (e.g., do not disturb mode, working mode, family mode, or any other mode). In some examples, a focus mode includes one or more preferences (e.g., user determined preferences) for notification suppression, delay, and presentation for one or more applications and/or senders. In some examples, the context 402 includes location-based data and/or time data. In some examples, a location and/or time influences the focus mode of the electronic device. For example, at an airport location, the electronic device 101 is optionally in an airport focus mode where airline notifications are displayed with higher priority.

For example, in FIG. 3A, the context includes that the user is at home, the user is currently watching television 302, the user is not focused on the television 302 (e.g., the gaze-based data indicates that the user is not fully focused on the television), and the electronic device 101 is not in a focus mode. For example, in FIGS. 3B through 3D, the context includes that the user is working in a laptop. For example, the electronic device 101 detects, using gaze data and image data, that the user is looking at a laptop 316 and working. Additionally, in some examples, the electronic device 101 is in a focus mode (e.g., a work mode) in FIGS. 3B through 3D.

The preferences 408 of the electronic device 101 also inform the situation 404 in some examples. Additionally, the preferences 408 also informs a relevance 410 and urgency 412 criteria to be used to determine whether the electronic device 101 presents an indication of a respective notification. In some examples, the preferences 408 prior to detecting the event 406 inform the situation 404, relevance 410 and urgency 412, and the preferences arising after detecting the event inform future situations, relevance, and urgency. In some examples, the preferences 408 are one or more preferences set by a user for one or more notifications. For example, focus modes have notification preferences (e.g., when to present and when to suppress a notification, as described above). In some examples, the preferences 408 may include a preference set by a user such that notifications from senders that are designated contacts have a higher urgency and/or relevance than notifications from senders that are not designated contacts. Alternatively, or additionally, in some examples, the electronic device 101 uses a lower importance threshold to evaluate notifications from senders that are designated contacts and a higher importance threshold to evaluate notifications from senders that are not designated contacts. In some examples, the user is able to determine designated contacts (e.g., while in a focus mode or while out of a focus mode). In some examples, the preferences 408 includes a timeliness of a notification. For example, the application associated with the notification can define a notification as time-sensitive, which may cause the urgency of a respective notification to be higher than the urgency would be were the notification not designated as time-sensitive. In some examples, the preferences 408 includes one or more preferences inferred by the electronic device 101 based on previous interactions with prior similar notifications (e.g., notifications with similar content), prior notifications from a sender of the notification, and/or prior notifications from a respective application. For example, if a user historically dismisses or deletes notifications with similar content, from a respective sender, and/or from a respective application (e.g., without other interaction with the notification(s)), then the relevance 410 and/or urgency 412 of the notification associated with the event 406 is lower than it would be without such history. Alternatively, in some examples, if the electronic device 101 detects that a user historically views and/or performs actions as a result of the electronic device 101 presenting an indication of a notification, then the relevance 410 and/or urgency 412 of the notification associated with the event 406 is greater than it would be without such history.

In some examples, if the relevance 410 and urgency 412 of a notification causes the notification to have an importance level greater than a threshold importance level, then the electronic device 101 presents an indication of the notification, shown as notification 414 in FIG. 4. For example, the situation 404 informs a busyness level of the electronic device 101 which is associated with a threshold importance level. Additionally, the situation 404, event 406, and preferences 408 determine an importance level of a notification.

In some examples, the electronic device 101 learns (e.g., learning 416) from the one or more interactions with the notification 414 to inform the preferences 408, relevance 410, and/or urgency 412 of future situations. For example, if the electronic device 101 detects that the user interacts with the notification 414 (e.g., engaging with the contents of the notification 414, reading the contents of the notification 414, and/or performing actions as a result of the notification 414), then the electronic device 101 may classify future situations including similar notifications with higher relevance and/or urgency. Similarly, if the electronic device 101 detects that the user does not interact with the notification 414 (e.g., dismissing the notification 414, deleting the notification 414, and/or ignoring the notification 414), then the electronic device 101 may classify future situations including similar notifications with lower relevance and/or urgency.

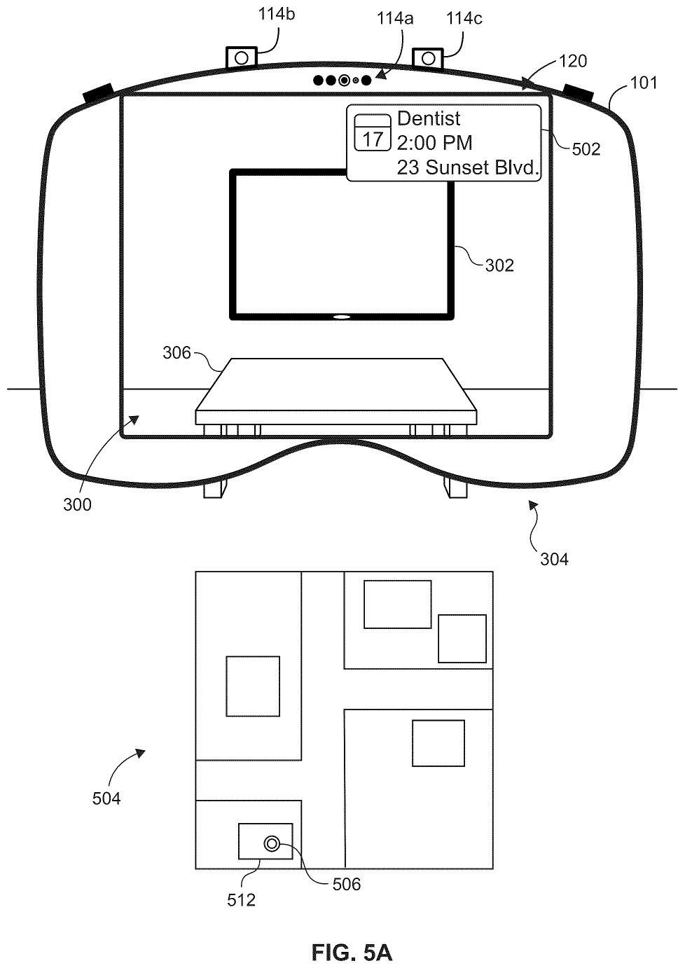

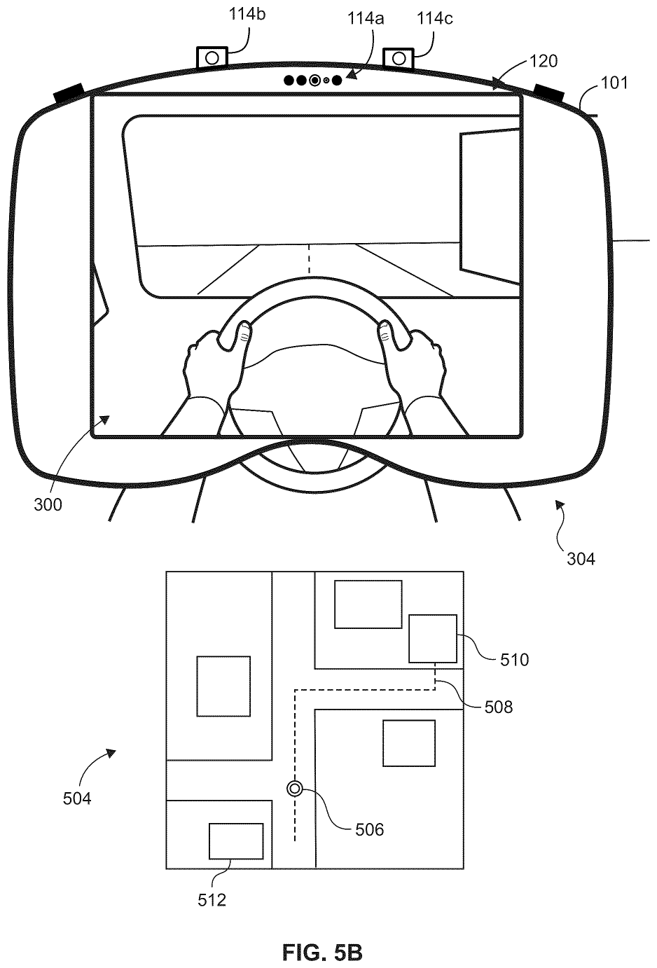

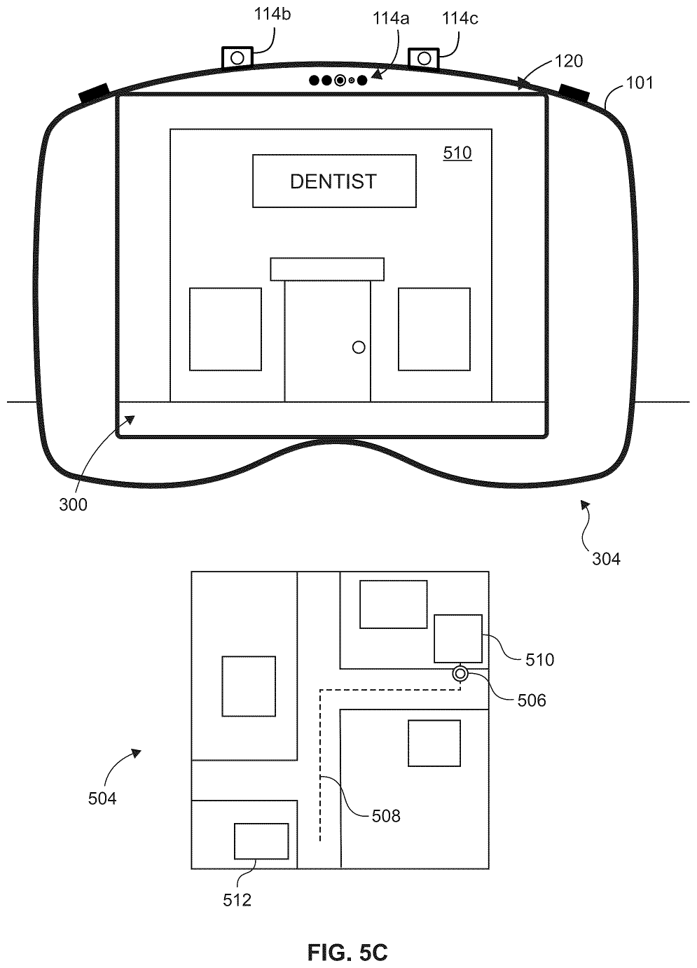

FIGS. 5A-5C illustrate examples of the electronic device 101 receiving and presenting notifications associated with respective locations. FIG. 5A includes one or more components and characteristics of FIG. 3A, such as television 302 and table 306. In FIG. 5A, the electronic device 101 receives a notification from a calendar application that has an importance greater than the importance threshold, described above. In FIG. 5A, the electronic device 101 presents an indication 502 of the notification. The indication 502 of the notification includes a location (e.g., “23 Sunset Blvd”) associated with the notification. In FIG. 5A, the electronic device 101 presents the indication 502 because the electronic device 101 detects that the user is not at the location associated with the notification. In some examples, the electronic device 101 presents the indication 502 because the electronic device 101 detects that it is time to move from the current location of the electronic device 101 to the location associated with the notification (e.g., using traffic data, navigation data, and/or GPS data). In some examples, the electronic device 101 presents the indication 502 because the indication 502 includes metadata to present the indication 502 at a specific location (e.g., the current location of the electronic device 101 in FIG. 5A) and/or time. FIG. 5A also includes a representation 504 of a map including a current location 506 of the electronic device 101. In FIG. 5A the location 506 of the electronic device 101 is in house 512, where the television 302 and table 306 are located. In this example, the location of house 512 is different from the location associated with the notification corresponding to indication 502.

In FIG. 5B, the electronic device 101 moves locations to travel from house 512 to the dentist's office 510. Representation 504 includes a path 508 that the electronic device 101 travels to move from the house 512 to the dentist's office 510. In FIG. 5B, the current location 506 of the electronic device 101 is on a road, and the three-dimensional environment 300 and physical environment 304 reflects that. The electronic device 101 presents one or more objects in the three-dimensional environment 300 indicating that the electronic device 101 is in a car and the user is driving to the dentist's office 510. In FIG. 5B, the electronic device 101 no longer presents indication 502 because the electronic device 101 detects that the electronic device 101 is moving towards the respective location of the notification. In some examples, the electronic device 101 ceases presenting indication 502 on electronic device 101 and continues and/or begins presenting the indication 502 of the notification on a second electronic device in communication with the electronic device 101. In some examples, the second electronic device is a phone, watch, laptop, tablet, or other device in communication with the electronic device 101.

FIG. 5C illustrates that the current location 506 of the electronic device 101 is at/near the dentist's office 510 (the location associated with the notification corresponding to the indication 502 shown in FIG. 5A). In FIG. 5C, the electronic device 101 does not present the indication 502 because the electronic device 101 detects that the current location 506 of the electronic device 101 is at the respective location of the indication 502. In some examples, the electronic device 101 ceases presenting indication 502 when the electronic device 101 detects that one or more criteria are satisfied. In some examples, the one or more criteria include a criterion that is satisfied when the electronic device 101 is moving towards the respective location of the indication 502, as shown in FIG. 5B. Alternatively or additionally, the one or more criteria include a criterion that is satisfied when the electronic device 101 detects that the current location of the electronic device 101 is within a threshold distance of the respective location of the indication 502. For example, the threshold distance is within 5 miles, 1 mile, 0.5 miles, 0.25 miles, 0.1 miles, or 0.01 miles of the respective location. In some examples, the electronic device 101 stops presenting the indication 502 when the electronic device 101 detects that the current location of the electronic device 101 is within a threshold distance of the respective location of the indication because the indication 502 is no longer relevant (e.g., the user is already at the location of the event). In some examples, the indication 502 is no longer relevant because the importance level of the indication 502 no longer meets the threshold importance (e.g., the electronic device 101 decreases the importance level of the indication 502 while within the threshold distance). Importance levels are described in greater detail in FIGS. 3A-3E and in FIG. 4. Ceasing displaying the indication 502 reduces the number of inputs needed to dismiss irrelevant notifications, thereby improving user-device interaction.

FIG. 6 illustrates a flow diagram illustrating an example process for presenting an indication of a notification according to some examples of the disclosure. In some examples, an electronic device in communication with a display and one or more input devices performs process 600 and/or one or more operations included in process 600. In some examples, the electronic device is optionally a head-mounted display similar or corresponding to electronic device 201 of FIG. 2 and/or electronic device 101 of FIG. 1. As shown in FIG. 6, in some examples, at 602, the electronic device determines, via at least the one or more input devices, a level of busyness of the user. For example, the level of busyness of the user is determined by one or more factors such as context 402 and preference 408, shown in FIG. 4. In some examples, at 604, while at a first level of busyness, the electronic device receives, via the one or more input devices, a notification from a first application. For example, the electronic device 101 receives notification 308, shown in FIG. 3A or notification 318, shown in FIG. 3C. In some examples, at 606, in response to receiving the notification, the electronic device determines (e.g., classifies), at 610, an importance of the notification based on contents of the notification. For example, the electronic device determines (e.g., classifies) the importance of the notification using the preferences 408 of the user, a relevance 410, and urgency 412 criteria, shown in FIG. 4.

In some examples, at 606, in response to receiving the notification, in accordance with a determination that the notification satisfies one or more first criteria, the one or more first criteria including a criterion that is satisfied when the importance of the notification is greater than a first threshold that is based on the level of busyness of the user, the electronic device presents, at 610, an indication of the notification from the first application on the electronic device. For example, in FIG. 3A, the importance level 314a of the notification is greater than the threshold level, T1, so the electronic device 101 presents indication 310 in the three-dimensional environment 300.

In some examples, at 606, in response to receiving the notification, in accordance with a determination that the notification does not satisfy the one or more first criteria, the electronic device forgoes the presentation, at 612, of the indication of the notification from the first application on the electronic device. For example, in FIG. 3B, the importance level 314a of the notification is lower than the threshold level, T2, so the electronic device 101 does not present an indication of the notification.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising at an electronic device with one or more displays and one or more input devices: determining, via at least the one or more input devices, a level of busyness of a user; while at a first level of busyness, receiving, via the one or more input devices, a notification from a first application; in response to receiving the notification: determining an importance of the notification based on contents of the notification; in accordance with a determination that the notification satisfies one or more first criteria, the one or more first criteria including a criterion that is satisfied when the importance of the notification is greater than a first threshold that is based on the level of busyness of the user, presenting an indication of the notification from the first application on the electronic device; and in accordance with a determination that the notification does not satisfy the one or more first criteria, forgoing presenting the indication of the notification from the first application on the electronic device. Additionally or alternatively to one of more of the examples disclosed above, in some examples, the level of busyness of the user is based on environmental context. Additionally or alternatively to one of more of the examples disclosed above, in some examples, the level of busyness of the user is based on application data. Additionally or alternatively to one of more of the examples disclosed above, in some examples, the method further comprises the importance of the notification is further based on prior interactions with prior notifications from the first application. Additionally or alternatively to one of more of the examples disclosed above, in some examples, the method further comprises determining the importance of the notification based on prior interactions with prior notifications from a sender of the notification. Additionally or alternatively to one of more of the examples disclosed above, in some examples, the method further comprises determining the importance of the notification based on prior interactions with prior notifications with the contents of the notification. Additionally or alternatively to one of more of the examples disclosed above, in some examples, the first threshold is determined based on a sender of the notification. Additionally or alternatively to one of more of the examples disclosed above, in some examples, the first threshold is relatively lower when the sender corresponds to a designated contact compared with when the sender does not correspond to a designated contact. Additionally or alternatively to one of more of the examples disclosed above, in some examples, presenting the indication of the notification further comprises: in accordance with a determination that the notification satisfies one or more second criteria, the one or more second criteria including a criterion that is satisfied when the importance of the notification is greater than a second threshold that is based on the level of busyness of the user greater than the first threshold that is based on the level, presenting the indication of the notification with a first visual characteristic; and in accordance with a determination that the notification fails to satisfy the one or more second criteria, presenting the indication of the notification with a second visual characteristic different than the first visual characteristic. Additionally or alternatively to one of more of the examples disclosed above, in some examples, the method further comprises while presenting the notification with the second visual characteristic, detecting, via the one or more input devices, an input directed to the notification with the second visual characteristic; and in response to the input satisfying one or more third criteria, presenting the notification with the first visual characteristic. Additionally or alternatively to one of more of the examples disclosed above, in some examples, the indication of the notification with the first visual characteristic includes a text or graphical representation of the contents of the notification. Additionally or alternatively to one of more of the examples disclosed above, in some examples, the indication of the notification with the second visual characteristic does not include a text or graphical representation of the contents of the notification. Additionally or alternatively to one of more of the examples disclosed above, in some examples, the one or more third criteria include a criterion that is satisfied when the input is maintained for a threshold amount of time. Additionally or alternatively to one of more of the examples disclosed above, in some examples, the method further comprises in response to the input failing to satisfy the one or more third criteria within a threshold amount of time, ceasing presenting the indication of the notification. Additionally or alternatively to one of more of the examples disclosed above, in some examples, the threshold amount of time is based on the importance of the notification. Additionally or alternatively to one of more of the examples disclosed above, in some examples, the method further comprises detecting, via the one or more input devices, a location of the electronic device; in response to receiving the notification from the first application and in accordance with a determination that the notification is associated with a respective location: in accordance with a determination that one or more criteria are satisfied, the one or more fourth criteria including a criterion that is satisfied when the electronic device is moving toward the respective location based on the location of the electronic device, forgoing presenting the indication of the notification from the first application via the one or more displays of the electronic device; and in accordance with a determination that the one or more fourth criteria are not satisfied, presenting of the indication of the notification from the first application via the one or more displays of the electronic device. Additionally or alternatively to one of more of the examples disclosed above, in some examples, forgoing presenting the indication of the notification includes forgoing presenting the indication of the notification from the first application via the one or more displays of the electronic device and presenting the indication of the notification from the first application via a display of a second electronic device in communication with the electronic device.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's current location.

The present disclosure recognizes that the use of such personal information data, in the present technology, can be used to the benefit of users. For example, personal information data may be used to display suggested text that changes based on changes in a user's biometric data. For example, the suggested text is updated based on changes to the user's age, height, weight, and/or health history.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device with one or more displays and one or more input devices:
determining, via at least the one or more input devices, a level of busyness of a user;
while at a first level of busyness, receiving a notification from a first application;
in response to receiving the notification:
determining an importance of the notification based on contents of the notification;
in accordance with a determination that the notification satisfies one or more first criteria, the one or more first criteria including a criterion that is satisfied when the importance of the notification is greater than a first threshold that is based on the level of busyness of the user, presenting an indication of the notification from the first application on the electronic device; and
in accordance with a determination that the notification does not satisfy the one or more first criteria, forgoing presenting the indication of the notification from the first application on the electronic device.

2. The method of claim 1, wherein the level of busyness of the user is based on at least one of environmental context and/or application data.

3. The method of claim 1, wherein determining the importance of the notification is further based on at least one of prior interactions with prior notifications from the first application, prior interactions with prior notifications from a sender of the notification, and/or prior interactions with prior notifications with contents of the notification.

4. The method of claim 1, wherein the first threshold is determined based on a sender of the notification.

5. The method of claim 1, wherein presenting the indication of the notification further comprises:
in accordance with a determination that the notification satisfies one or more second criteria, the one or more second criteria including a criterion that is satisfied when the importance of the notification is greater than a second threshold that is based on the level of busyness of the user greater than the first threshold that is based on the level, presenting the indication of the notification with a first visual characteristic; and
in accordance with a determination that the notification fails to satisfy the one or more second criteria, presenting the indication of the notification with a second visual characteristic different than the first visual characteristic.

6. The method of claim 5, further comprising:
while presenting the notification with the second visual characteristic, detecting, via the one or more input devices, an input directed to the notification with the second visual characteristic; and
in response to the input satisfying one or more third criteria, presenting the notification with the first visual characteristic.

7. The method of claim 6, wherein the indication of the notification with the first visual characteristic includes a text or graphical representation of the contents of the notification; and
the indication of the notification with the second visual characteristic does not include a text or graphical representation of the contents of the notification.

8. The method of claim 1, further comprising:
detecting, via the one or more input devices, a location of the electronic device;
in response to receiving the notification from the first application and in accordance with a determination that the notification is associated with a respective location:
in accordance with a determination that one or more fourth criteria are satisfied, the one or more fourth criteria including a criterion that is satisfied when the electronic device is moving toward the respective location based on the location of the electronic device, forgoing presenting the indication of the notification from the first application via the one or more displays of the electronic device; and
in accordance with a determination that the one or more fourth criteria are not satisfied, presenting of the indication of the notification from the first application via the one or more displays of the electronic device.

9. An electronic device, comprising:
one or more processors;
memory; and
one or more programs, wherein the one or more programs are stored in the memory and configured to be executed by the one or more processors, the one or more programs including instructions for:
determining, via at least one or more input devices, a level of busyness of a user;
while at a first level of busyness, receiving a notification from a first application;
in response to receiving the notification:
determining an importance of the notification based on contents of the notification;
in accordance with a determination that the notification satisfies one or more first criteria, the one or more first criteria including a criterion that is satisfied when the importance of the notification is greater than a first threshold that is based on the level of busyness of the user, presenting an indication of the notification from the first application on the electronic device; and
in accordance with a determination that the notification does not satisfy the one or more first criteria, forgoing presenting the indication of the notification from the first application on the electronic device.

10. The electronic device of claim 9, wherein the level of busyness of the user is based on at least one of environmental context and/or application data.

11. The electronic device of claim 9, wherein determining the importance of the notification is further based on at least one of prior interactions with prior notifications from the first application, prior interactions with prior notifications from a sender of the notification, and/or prior interactions with prior notifications with contents of the notification.

12. The electronic device of claim 9, wherein the first threshold is determined based on a sender of the notification.

13. The electronic device of claim 9, wherein presenting the indication of the notification further comprises:
in accordance with a determination that the notification satisfies one or more second criteria, the one or more second criteria including a criterion that is satisfied when the importance of the notification is greater than a second threshold that is based on the level of busyness of the user greater than the first threshold that is based on the level, presenting the indication of the notification with a first visual characteristic; and
in accordance with a determination that the notification fails to satisfy the one or more second criteria, presenting the indication of the notification with a second visual characteristic different than the first visual characteristic.

14. The electronic device of claim 13, the one or more programs further including instructions for:
while presenting the notification with the second visual characteristic, detecting, via the one or more input devices, an input directed to the notification with the second visual characteristic; and
in response to the input satisfying one or more third criteria, presenting the notification with the first visual characteristic.

15. The electronic device of claim 13, wherein the indication of the notification with the first visual characteristic includes a text or graphical representation of the contents of the notification; and
the indication of the notification with the second visual characteristic does not include a text or graphical representation of the contents of the notification.

16. The electronic device of claim 9, the one or more programs further including instructions for:
detecting, via the one or more input devices, a location of the electronic device;
in response to receiving the notification from the first application and in accordance with a determination that the notification is associated with a respective location:
in accordance with a determination that one or more fourth criteria are satisfied, the one or more fourth criteria including a criterion that is satisfied when the electronic device is moving toward the respective location based on the location of the electronic device, forgoing presenting the indication of the notification from the first application via the one or more displays of the electronic device; and
in accordance with a determination that the one or more fourth criteria are not satisfied, presenting of the indication of the notification from the first application via the one or more displays of the electronic device.

17. A non-transitory computer readable storage medium storing one or more programs, the one or more programs comprising instructions, which when executed by one or more processors of an electronic device, cause the electronic device to perform a method comprising:
determining, via at least one or more input devices, a level of busyness of a user;
while at a first level of busyness, receiving a notification from a first application;
in response to receiving the notification:
determining an importance of the notification based on contents of the notification;
in accordance with a determination that the notification satisfies one or more first criteria, the one or more first criteria including a criterion that is satisfied when the importance of the notification is greater than a first threshold that is based on the level of busyness of the user, presenting an indication of the notification from the first application on the electronic device; and
in accordance with a determination that the notification does not satisfy the one or more first criteria, forgoing presenting the indication of the notification from the first application on the electronic device.

18. The non-transitory computer readable storage medium of claim 17, wherein the level of busyness of the user is based on at least one of environmental context and/or application data.

19. The non-transitory computer readable storage medium of claim 17, wherein determining the importance of the notification is further based on at least one of prior interactions with prior notifications from the first application, prior interactions with prior notifications from a sender of the notification, and/or prior interactions with prior notifications with contents of the notification.

20. The non-transitory computer readable storage medium of claim 17, wherein the first threshold is determined based on a sender of the notification.

21. The non-transitory computer readable storage medium of claim 17, wherein presenting the indication of the notification further comprises:
in accordance with a determination that the notification satisfies one or more second criteria, the one or more second criteria including a criterion that is satisfied when the importance of the notification is greater than a second threshold that is based on the level of busyness of the user greater than the first threshold that is based on the level, presenting the indication of the notification with a first visual characteristic; and
in accordance with a determination that the notification fails to satisfy the one or more second criteria, presenting the indication of the notification with a second visual characteristic different than the first visual characteristic.

22. The non-transitory computer readable storage medium of claim 21, the method further comprising:
while presenting the notification with the second visual characteristic, detecting, via the one or more input devices, an input directed to the notification with the second visual characteristic; and
in response to the input satisfying one or more third criteria, presenting the notification with the first visual characteristic.

23. The non-transitory computer readable storage medium of claim 21, wherein the indication of the notification with the first visual characteristic includes a text or graphical representation of the contents of the notification; and
the indication of the notification with the second visual characteristic does not include a text or graphical representation of the contents of the notification.

24. The non-transitory computer readable storage medium of claim 17, the method further comprising:
detecting, via the one or more input devices, a location of the electronic device;
in response to receiving the notification from the first application and in accordance with a determination that the notification is associated with a respective location:
in accordance with a determination that one or more fourth criteria are satisfied, the one or more fourth criteria including a criterion that is satisfied when the electronic device is moving toward the respective location based on the location of the electronic device, forgoing presenting the indication of the notification from the first application via the one or more displays of the electronic device; and
in accordance with a determination that the one or more fourth criteria are not satisfied, presenting of the indication of the notification from the first application via the one or more displays of the electronic device.
